(19) United States
(12) Patent Application Publication
(10) Pub. No.: US 2016/0120741 A1
(43) Pub. Date: May 5, 2016

(54) SPA HAVING INTEGRATED ICE BUCKET AND LID

(71) Applicants: WADE SPICER, WATSONTOWN, PA (US); KRAIG OLSEN, CRYSTAL LAKE, IL (US); KYLE HAMILTON, DANVILLE, PA (US)

(72) Inventors: WADE SPICER, WATSONTOWN, PA (US); KRAIG OLSEN, CRYSTAL LAKE, IL (US); KYLE HAMILTON, DANVILLE, PA (US)

(73) Assignee: Strong Industries, Inc., Northumberland, PA (US)

(21) Appl. No.: 14/930,821

(22) Filed: Nov. 3, 2015

Related U.S. Application Data
(60) Provisional application No. 62/075,411, filed on Nov. 5, 2014.

(51) Int. Cl. A61H 33/00; E04H 4/08

(52) U.S. Cl. CPC A61H 33/6005; E04H 4/08; A61H 33/0087

(57) ABSTRACT

A spa includes a base and a shell supported by the base. The shell includes a cavity defining an ice bucket and a lid positioned atop the cavity. The lid is selectively movable from a first position atop the cavity, to a second position in which the lid is positioned adjacent to the cavity in a substantially horizontal orientation such that access to the cavity is facilitated and the lid is capable of supporting the weight of an item.

### CROSS-REFERENCE TO RELATED APPLICATIONS

This application claims the benefit of U.S. Provisional Application Ser. No. 62/075,411, filed on Nov. 5, 2014, which is herein incorporated by reference in its entirety.

### FIELD OF THE INVENTION

The present invention relates generally to spas and, more particularly, to a spa having an integrated ice bucket.

### BACKGROUND OF THE INVENTION

Spas, also commonly known as hot tubs, are generally relatively deep rotationally-molded, blow-molded or vacuum-formed tubs provided with an external decorative enclosure surrounding the tub. Typically, the acrylic liner of the spa is formed into shapes that provide a variety of seating arrangements within the tub. Each seating arrangement may be provided with a number of fixtures including water jet fixtures which are operated by a water pump, and/or air jet fixtures which are operated by an air blower. The water pump and/or the air blower are housed between the tub and the enclosure.

The appeal of hot tubs and spas is primarily due to the hydrotherapy and bubbling action provided by water jet fixture and/or air jet fixtures recessed into the tub wall which provide a massaging action. In addition, unlike a bath tub which may be fitted with the fixtures but must be filled and emptied with each use, a spa tub is intended to retain the water provided therein over many uses, and preferably continually maintains the water at a heated temperature, e.g., 98 to 108 degrees Fahrenheit. This is accomplished by providing a water jacket around the water pump which utilizes heat generated by the water pump to heat the water and/or by utilizing a separate water heater element. Therefore, the spa tub is always ready for immediate use. Further, because the water is always warm, spa tubs may be used indoors and outdoors throughout the year.

While existing spas are generally suitable for what can be regarded as ordinary performance, there is room for improvement in terms of added features and devices that may make utilizing the spa more enjoyable for the user.

### SUMMARY OF THE INVENTION

It is an object of the present invention to provide a spa.

It is another object of the present invention to provide a spa having an integrated ice bucket.

It is another object of the present invention to provide a spa having a lid for the integrated ice bucket.

It is another object of the present invention to provide a spa having a lid for an ice bucket that may be utilized as a table top or shelf for drinks.

It is another object of the present invention to provide a spa having a lid for an ice bucket that can be selectively moved to various positions within the spa to be used as a shelf for drinks.

In an embodiment, a spa is provided. The spa includes a base and a shell supported by the base. The shell includes a cavity defining an ice bucket and a lid positioned atop the cavity. The lid is selectively movable from a first position atop the cavity, to a second position in which the lid is positioned adjacent to the cavity in a substantially horizontal orientation such that access to the cavity is facilitated and the lid is capable of supporting the weight of an item.

In another embodiment, a shell for a spa is provided. The shell includes a plurality of seating positions including at least a first seating position and a second seating position, a cavity formed in the shell intermediate the first seating position and the second seating position, and a lid configured to rest atop the cavity to enclose the cavity, the lid being movable between a first position in which the lid rests substantially atop the cavity and a second position in which the lid is positioned in spaced relation to the cavity permitting access to said cavity from above.

### BRIEF DESCRIPTION OF THE DRAWINGS

The present invention will be better understood from reading the following description of non-limiting embodiments, with reference to the attached drawings, wherein below:

FIG. 1 is a perspective view of a spa having an integrated ice bucket and lid in accordance with an embodiment of the present invention, illustrating the lid in a covered position.

FIG. 2 is a perspective view of the spa having an integrated ice bucket and lid of FIG. 1, illustrating the lid in an extended position.

FIG. 3 is a perspective view of the lid of the ice bucket, according to an embodiment of the present invention.

FIG. 4 is a cross-sectional, detail view of the ice bucket and lid, illustrating the lid in a covered position.

FIG. 5 is a cross-sectional, detail view of the ice bucket and lid, illustrating the lid in an extended position.

### DETAILED DESCRIPTION OF THE PREFERRED EMBODIMENTS

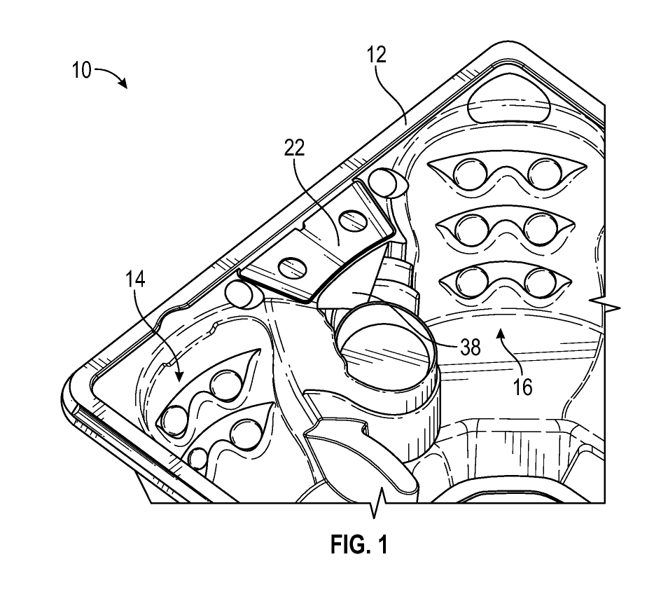

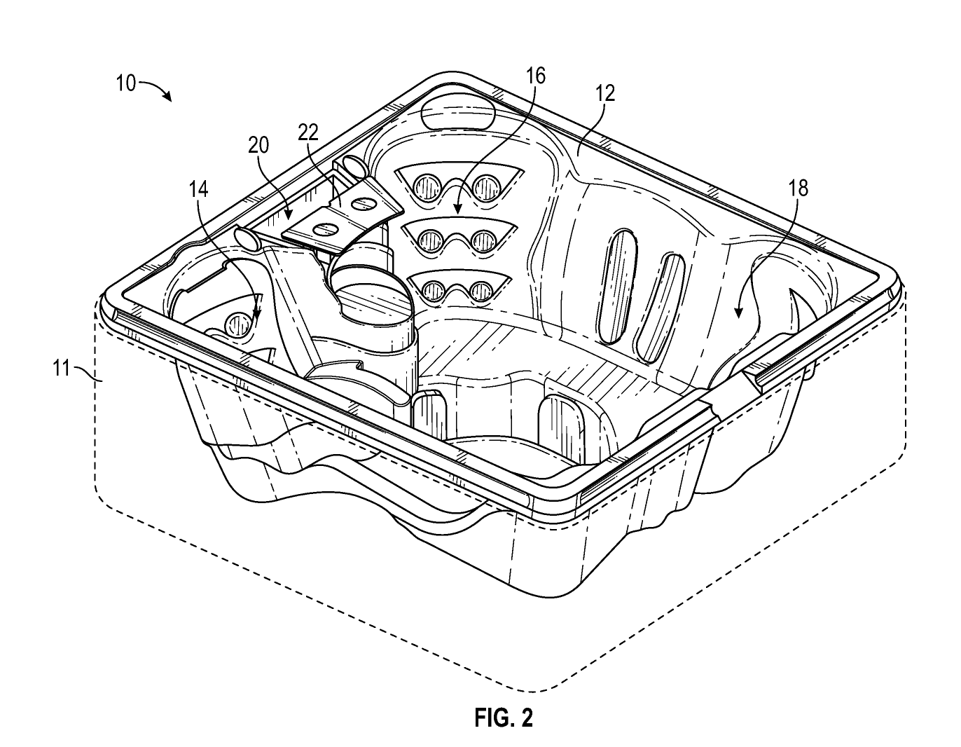

Referring to FIGS. 1 and 2, a spa 10 having an integrated ice bucket according to an embodiment of the present invention is shown. The spa 10 may be of any type known in the art and includes a base defining a spa cabinet 11 (shown in phantom), and an acrylic shell 12 supported by the base. In particular, the spa cabinet serves as the support structure of the spa 10 and may be of any type known in the art, such as framed or sub-frameless.

As best shown in FIGS. 1 and 2, the shell 12 may be a rotationally-molded, blow-molded or vacuum-formed acrylic shell as known in the art, and may have a plurality of seating arrangements 14, 16, 18. As best shown in FIG. 2, the shell 12 may be formed with an integrated cavity 20 intermediate two of the seating arrangements 14, 16. In the preferred embodiment, the cavity 20 may be utilized to hold ice and cold beverages, as discussed in detail below. In an embodiment, the cavity 20 may be insulated from ambient, as well as from the hot water within the spa. As illustrated, the cavity may be generally rectangular in shape. As also shown in FIG. 1, the spa 10 may also include a lid 22 configured to cover the cavity 20. As shown in FIGS. 1 and 2, the lid 22 may be selectively movable from a first position, in which it substantially covers the top of the cavity 20, to a second position, in which it does not cover the cavity 22 and rests in substantially horizontal position adjacent to the cavity 20. As will be readily appreciated, in this second, extended position, the lid 22 can function as a table top or other support surface for holding beverages or other items.

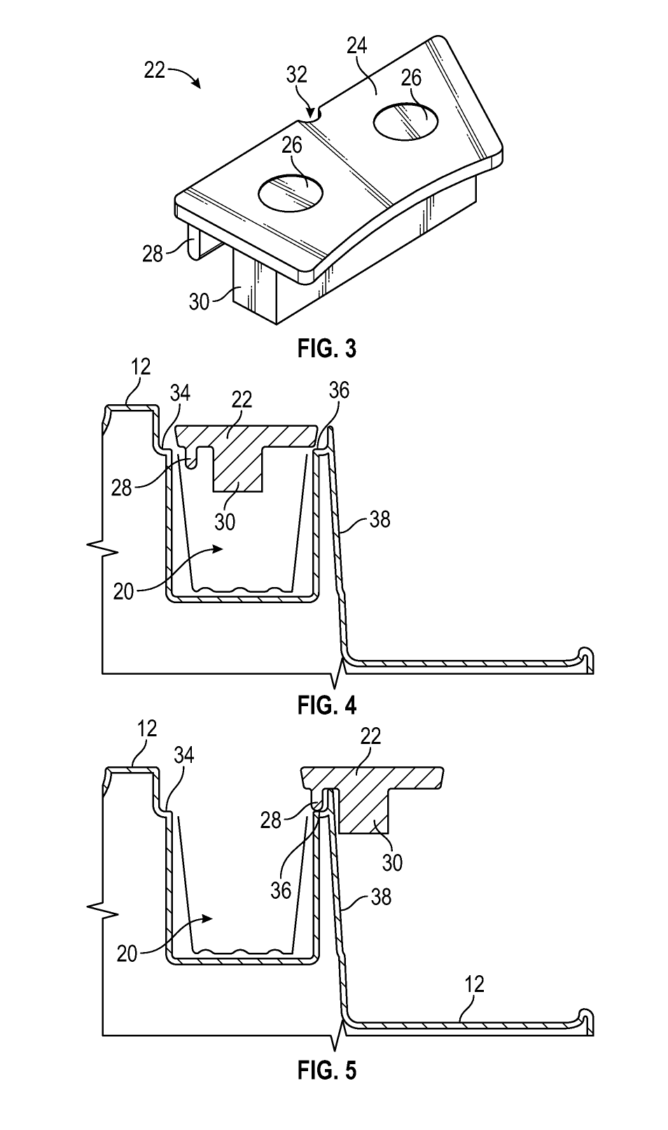

Turning now to FIG. 3, the lid 22 is illustrated. As shown, the lid 22 includes a generally planar top surface 24 formed with a plurality of circular depressions 26 configured to hold cups or beverages. A first depending leg 28 adjacent to the rear of the lid 22 extends downward from a bottom surface thereof, and a second depending leg 30 extends downward from the bottom surface adjacent to the front thereof. As also shown in FIG. 3, the lid 22 includes a cutout portion 32 which allows a user to move the lid 22 from the first position to the second position.

With reference to FIGS. 4 and 5, operation of the lid 22 is illustrated. As shown in FIG. 4, in the covered position, the lid 22 rests atop the cavity 20 and is supported in such position by opposed shoulders 34, 36 of the cavity 20. As illustrated in FIG. 5, in the extended position, an outer wall 38 of the cavity 20 supports the lid 22 in a substantially horizontal position. In particular, the lid 22 is supported in this position by the contact of the second depending leg 30 with the outer wall 38, as illustrated in FIG. 5. Indeed, as will be readily appreciated, in the extended position, the second depending leg 30 bears upon the shell 12 (and, in particular, the outer wall 38 of the cavity 20), retaining the lid 22 in the horizontal position. Importantly, in this extended position, the lid 22 is capable of functioning as a support surface or table for beverages and the like. In an embodiment, the lid 22 is capable of supporting the weight of user items, such as the weight of multiple cans of a beverage or glasses filled with liquid.

In an embodiment, the lid 22 may be removed fully from atop the cavity 20 and can be positioned at various locations around the spa 10, depending upon the preferences of the user.

As will be readily appreciated, the integrated cavity 20/ice bucket and lid 22 thereof provides a user with an additional feature not found on existing spas. In particular, the ice bucket allows a user to make cold beverages while enjoying massage therapy. Moreover, the lid 22 provides dual functionality, as a cover for the cavity 20 keeping ice cold, and as a table top or support surface for beverages.

Although this invention has been shown and described with respect to the detailed embodiments thereof, it will be understood by those of skill in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above detailed description, but that the invention will include all embodiments falling within the scope of this disclosure.

What is claimed is:

1. A spa, comprising:
a base;
a shell supported by the base;
a cavity formed in the shell; and
a lid configured to rest atop said cavity to enclose said cavity, said lid being movable between a first position in which said lid rests substantially atop said cavity and a second position in which said lid is positioned in spaced relation to said cavity permitting access to said cavity;
wherein in said second position said lid is capable of supporting an item.

2. The spa of claim 1, wherein:
when in said second position, a top surface of said lid is generally planar with a top lip of said shell.

3. The spa of claim 1, wherein:
said cavity includes opposed shoulders configured to support said lid in said first position.

4. The spa of claim 1, wherein:
said lid includes a top surface, a bottom surface, a first depending leg extending downwardly from said bottom surface adjacent to a first edge of said lid, and a second leg extending downwardly from said bottom surface and spaced from said first depending;
wherein said first leg and said second leg define a channel therebetween.

5. The spa of claim 4, wherein:
said cavity includes a front wall terminating in an upper lip; and
wherein in said second position said lip is captured in said channel and said second leg bears upon said front wall to maintain said top surface in a substantially horizontal orientation.

6. The spa of claim 4, wherein:
said lid includes at least one depression formed in a top surface thereof.

7. The spa of claim 6, wherein:
said lid includes a relieved area at said first edge of said lid.

8. The spa of claim 1, wherein:
said shell defines a plurality of seating positions including at least a first seating position and a second seating position; and
said cavity is formed in said shell intermediate said first and second seating positions.

9. The spa of claim 8, wherein:
said cavity is insulated.

10. A shell for a spa, comprising:
a plurality of seating positions including at least a first seating position and a second seating position; and
a cavity formed in said shell intermediate said first seating position and said second seating position; and
a lid configured to rest atop said cavity to enclose said cavity, said lid being movable between a first position in which said lid rests substantially atop said cavity and a second position in which said lid is positioned in spaced relation to said cavity permitting access to said cavity from above.

11. The shell of claim 10, wherein:
in said second position said lid is capable of supporting an item.

12. The shell of claim 11, wherein:
when in said second position, a top surface of said lid is generally planar with a top lip of said shell.

13. The shell of claim 12, wherein:
said cavity includes opposed shoulders configured to support said lid in said first position.

14. The shell of claim 13, wherein:
said lid includes a top surface, a bottom surface, a first depending leg extending downwardly from said bottom surface adjacent to a first edge of said lid, and a second leg extending downwardly from said bottom surface and spaced from said first depending;
wherein said first leg and said second leg define a channel therebetween.

15. The shell of claim 14, wherein:
said cavity includes a front wall terminating in an upper lip; and
wherein in said second position said lip is captured in said channel and said second leg bears upon said front wall to maintain said top surface in a substantially horizontal orientation.

16. The shell of claim 15, wherein:
said lid includes at least one depression formed in a top surface thereof.

17. The shell of claim 16, wherein:
said lid includes a relieved area at said first edge of said lid.

18. The shell of claim 10, wherein:
said cavity is insulated.
